(19) United States
(12) Patent Application Publication
(10) Pub. No.: US 2026/0017493 A1
(43) Pub. Date: Jan. 15, 2026

(54) CONVOLUTIONAL NEURAL NETWORK INFERENCE PROCESSING DEVICE, CONVOLUTIONAL NEURAL NETWORK INFERENCE PROCESSING METHOD, AND CONVOLUTIONAL NEURAL NETWORK INFERENCE PROCESSING PROGRAM

(71) Applicant: NIPPON TELEGRAPH AND TELEPHONE CORPORATION, Tokyo (JP)

(72) Inventors: Shuhei YOSHIDA, Tokyo (JP); Hiroyuki UZAWA, Tokyo (JP); Saki HATTA, Tokyo (JP); Yuko IINUMA, Tokyo (JP); Yuya OMORI, Tokyo (JP); Daisuke KOBAYASHI, Tokyo (JP); Ken NAKAMURA, Tokyo (JP)

(73) Assignee: NIPPON TELEGRAPH AND TELEPHONE CORPORATION, Tokyo (JP)

(21) Appl. No.: 18/992,098

(22) PCT Filed: Jul. 13, 2022
(86) PCT No.: PCT/JP2022/027591

§ 371 Date: Jan. 7, 2025

(51) Int. Cl. G06N 3/0464

(52) U.S. Cl. CPC G06N 3/0464

(57) ABSTRACT

A determination unit (33) determines a processing mode for minimizing a usage amount of an external memory band for each layer of a CNN among processing modes that are based on a sliding method in a case in which entire input data is processed by causing the plurality of convolution calculators to perform batch processing on a processing range in the input data that is input to each layer of the CNN by sliding the processing range, the processing modes including a first mode in which the input data is fixed and a kernel is slid, a second mode in which output data is fixed and the input data and the kernel are slid in a channel direction, and a third mode in which the kernel is fixed and the input data are slid in the vertical and horizontal directions. The setting unit (34) sets the determined processing mode in a calculation unit 35. The calculation unit (35) performs convolution calculation on the input data based on the set processing mode.

### TECHNICAL FIELD

The disclosed technique relates to a convolutional neural network inference processing device, a convolutional neural network inference processing method, and a convolutional neural network inference processing program.

### BACKGROUND ART

In recent years, image recognition, object recognition, and the like in which a convolutional neural network (CNN) is used have been applied for use cases in which real-time performance, power saving, and area saving of surveillance cameras, drones, and the like are obtained. Therefore, research and development of hardware used for CNN inference processing have been actively conducted. For example, when it is assumed that memory resources limited at edges are used, it is important to reduce a usage amount of external memory band.

In hardware used for CNN Inference processing, it is general to process the entire input image by performing batch processing with a predetermined range of the input image as a processing range by a plurality of convolution calculators developed in parallel and sliding the processing range.

### CITATION LIST

### Non Patent Literature

NPL 1 F. Indirli, A. Erdem and C. Silvano, “A Tile-based Fused-layer CNN Accelerator for FPGAs,” 2020 27th IEEE International Conference on Electronics, Circuits and Systems (ICECS), 2020, pp. 1-4, doi: 10.1109/ICECS49266.2020.9294981.

### SUMMARY OF INVENTION

### Technical Problem

When a plurality of convolution calculators loaded in parallel perform batch processing using a given range of an input image as a processing range, there are a plurality of patterns in a setting of the processing range and a slide order, and a usage amount of an external memory band differs depending on the patterns. An optimum pattern differs depends on a CNN layer, but a previously fixed pattern is generally applied, and thus an optimum pattern for minimizing the usage amount of an external memory band is not always applied.

The disclosed technique has been devised in consideration of the foregoing circumstances and an object of the disclosed technique is to reduce a usage amount of an external memory band in CNN processing.

### Solution to Problem

According to a first aspect of the present disclosure, a convolutional neural network inference processing device, includes: a setting unit configured to set a processing mode for minimizing a usage amount of an external memory band in a plurality of convolution calculators for each layer of a convolutional neural network among processing modes that are based on a sliding method in a case in which entire input data is processed by causing the plurality of convolution calculators to perform batch processing on a processing range in the input data that is input to each layer of the convolutional neural network and has vertical. horizontal, and channel direction values, and sliding the processing range, the processing modes including a first mode in which the input data is fixed and a kernel is slid, a second mode in which output data is fixed and the input data and the kernel are slid in a channel direction, and a third mode in which the kernel is fixed and the input data is slid in vertical and horizontal directions: and a calculation unit configured to perform convolution calculation on the input data based on the processing mode set by the setting unit.

According to a second aspect of the present disclosure, a convolutional neural network inference processing method, includes: setting, by a setting unit, a processing mode for minimizing a usage amount of an external memory band in a plurality of convolution calculators for each layer of a convolutional neural network among processing modes that are based on a sliding method in a case in which entire input data is processed by causing the plurality of convolution calculators to perform batch processing on a processing range in the input data that is input to each layer of the convolutional neural network and has vertical, horizontal, and channel direction values, and sliding the processing range, the processing modes including a first mode in which the input data is fixed and a kernel is slid, a second mode in which output data is fixed and the input data and the kernel are slid in a channel direction, and a third mode in which the kernel is fixed and the input data is slid in vertical and horizontal directions: and performing, by a calculation unit, convolution calculation on the input data based on the processing mode set by the setting unit.

According to a third aspect of the present disclosure, a convolutional neural network inference processing program causes a computer to function as: a setting unit that sets a processing mode for minimizing a usage amount of an external memory band in a plurality of convolution calculators for each layer of a convolutional neural network among processing modes that are based on a sliding method in a case in which entire input data is processed by causing the plurality of convolution calculators to perform batch processing on a processing range in the input data that is input to each layer of the convolutional neural network and has vertical, horizontal, and channel direction values, and sliding the processing range, the processing modes including a first mode in which the input data is fixed and a kernel is slid, a second mode in which output data is fixed and the input data and the kernel are slid in a channel direction, and a third mode in which the kernel is fixed and the input data is slid in vertical and horizontal directions: and a calculation unit that performs convolution calculation on the input data based on the processing mode set by the setting unit.

### Advantageous Effects of Invention

According to the disclosed technique, it is possible to reduce the usage amount of an external memory band in CNN processing.

### BRIEF DESCRIPTION OF DRAWINGS

FIG. 1 is a diagram illustrating examples of input data, kernels, and output data.

FIG. 2 is a block diagram illustrating a hardware configuration of a convolutional neural network reference processing device according to an embodiment.

FIG. 3 is a block diagram illustrating an example of a functional configuration of the convolutional neural network reference processing device according to the embodiment.

FIG. 4 is a diagram illustrating a calculation formula for calculating a usage amount of an external memory band for the input data, the output data, and the kernels.

FIG. 5 is a diagram illustrating examples of input data, kernels, and output data.

FIG. 6 is a diagram illustrating a processing example of each mode.

FIG. 7 is a diagram illustrating a calculation example of a usage amount of an external memory band for the input data, the output data, and the kernels.

FIG. 8 is a flowchart illustrating a flow of convolutional neural network reference processing according to the embodiment.

### DESCRIPTION OF EMBODIMENTS

Hereinafter, examples of embodiments of the disclosed technology will be described with reference to the drawings. In each drawing, the same or equivalent constituents and portions are denoted by the same reference numerals. Dimensional ratios in the drawings are exaggerated for convenience of description and may differ from actual ratios.

### Processing Mode

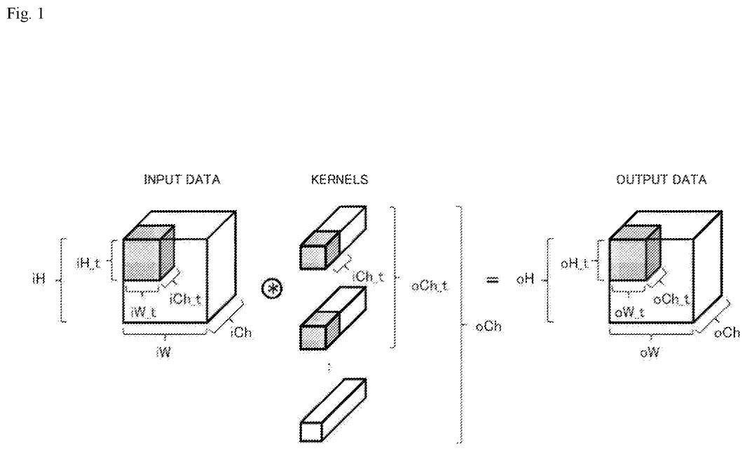

FIG. 1 illustrates examples of an input feature map (hereinafter referred to as “input data”) input to a certain convolutional layer of a CNN, a kernel applied to the convolutional layer, and an output feature map (hereinafter referred to as “output data”) output from the convolutional layer.

When a plurality of convolution calculators loaded in parallel perform batch processing using a certain range of input data as a processing range, as illustrated in FIG. 1, there are a plurality of combinations of vertical lengths, horizontal lengths, and channel direction lengths under the condition of a given volume in the processing range. In FIG. 1, a shaded portion is a processing range. In FIG. 1, it is assumed that iH is a vertical size of the input data, iW is a horizontal size of the input data, iCh is a channel direction size of the input data, iH_t is a vertical size of the processing range in the input data, iW_t is a horizontal size of the processing range, and iCh_t is a channel direction size of the processing range. It is assumed that oCh is the number of kernels, iCh is the number of kernels applied to the processing range, and iCh_t is a channel direction size of the kernels applied to the processing range. When oH is a vertical size of the output data, oW is a horizontal size of the output data, oCh is a channel direction size of the output data, oH_t is a vertical size of the output data corresponding to the processing range, oW_t is a horizontal size of the output data corresponding to the processing range, and oCh_t is a channel direction size of the output data corresponding to the processing range. The same applies to the following drawings.

A method of sliding the processing range is broadly classified into the following three methods.
(1) A method of fixing the input data and preferentially sliding the kernels.
(2) A method of fixing the output data and preferentially sliding the input data and kernels in a channel direction
(3) A method of fixing the kernels and preferentially sliding the input data in the vertical and horizontal directions

In the embodiment, a processing mode based on each of the three sliding methods is provided. Hereinafter, a processing mode based on the sliding method (1), that is, the processing mode in which reuse of the input data is preferred is referred to as “Mode 1”. A processing mode based on the sliding method (2), that is, the processing mode in which reuse of the output data is preferred, is referred to as “Mode 2”. A processing mode based on the sliding method (3), that is, the processing mode in which reuse of the kernels is preferred, is referred to as “Mode 3”. The term “reuse” is repeated use of data read to an internal memory in computation processing.

In the embodiment, a processing range and a processing mode for minimizing an external memory use band are set for each layer of a CNN, and convolution calculation is performed.

### Configuration of Convolutional Neural Network Inference Processing Device

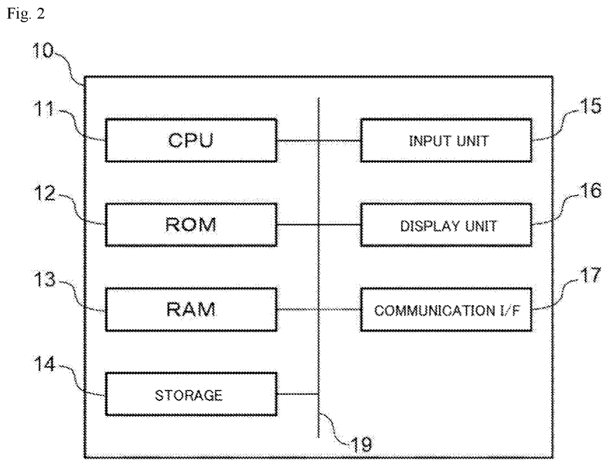

FIG. 2 is a block diagram illustrating a hardware configuration of a convolutional neural network inference processing device 10 according to the embodiment.

As illustrated in FIG. 2, the convolutional neural network inference processing device 10 includes a central processing unit (CPU) 11, a read only memory (ROM) 12, a random access memory (RAM) 13, a storage 14, an input unit 15, a display unit 16, and a communication interface (I/F) 17. The constituents are connected to be able to communicate each other via a bus 19.

The CPU 11 is a central processing unit and executes various programs or controls each unit. That is, the CPU 11 reads a program from the ROM 12 or the storage 14 and executes the program using the RAM 13 as a work area. The CPU 11 performs control of each configuration and various types of calculation processing according to programs stored in the ROM 12 or the storage 14. In the embodiment, a convolutional neural network inference processing program for performing the convolutional neural network inference processing to be described below is stored in the ROM 12 or the storage 14.

Various programs and various types of data are stored in the ROM 12. A program or data is temporarily stored in the RAM 13 that serves as a work area. The storage 14 includes a storage device such as a hard disk drive (HDD) or a solid state drive (SSD) and stores various programs including an operating system, and various pieces of data.

The input unit 15 includes a pointing device such as a mouse or a keyboard, and is used for various inputs. The display unit 16 is, for example, a liquid crystal display, and displays various types of information. A touch panel system may be adopted as the display unit 16 which may function as the input unit 15.

The communication I/F 17 is an interface for communication with other devices. For such communication, for example, a wired communication standard such as Ethernet (registered trademark) or FDDI, or a wireless communication standard such as 4G, 5G, or Wi-Fi (registered trademark) is used.

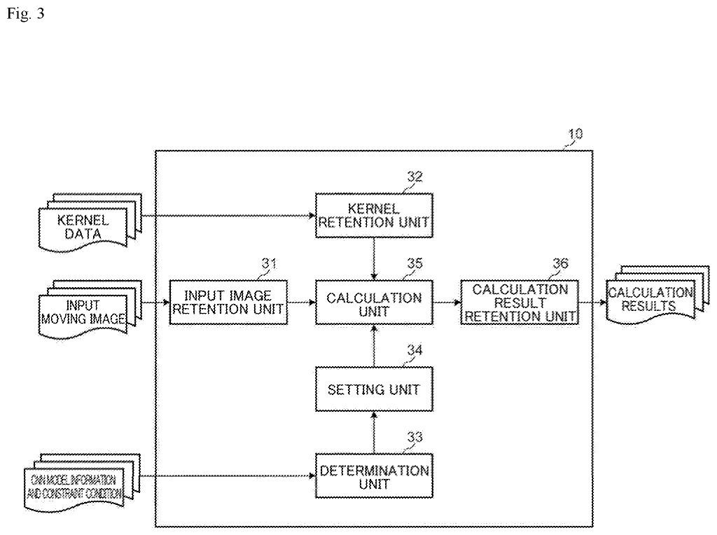

Next, a functional configuration of the convolutional neural network inference processing device 10 will be described. FIG. 3 is a block diagram illustrating an example of the functional configuration of the convolutional neural network inference processing device 10.

As illustrated in FIG. 3, the convolutional neural network inference processing device 10 includes, as functional constituents, an input image retention unit 31, a kernel retention unit 32, a determination unit 33, a setting unit 34, a calculation unit 35, and a calculation result retention unit 36. Each functional constituent is realized by the CPU 11 reading the convolutional neural network inference processing program stored in the ROM 12 or the storage 14, and loading and executing the convolutional neural network inference processing program on the RAM 13.

The input image retention unit 31 retains an input moving image input to the convolutional neural network inference processing device 10 in units of frames. Hereinafter, one frame of the input moving image is referred to as an “input image”. The input image retention unit 31 is provided in an external memory.

The kernel retention unit 32 retains kernel data, that is, a weighting coefficient of convolution calculation. The kernel retention unit 32 is provided in an external memory.

The determination unit 33 determines a processing mode in which a usage amount of the external memory band becomes a minimum among the above three processing modes. Specifically, the determination unit 33 determines a processing range and a processing mode for minimizing the usage amount of an external memory band under a constraint condition corresponding to the internal memory capacity.

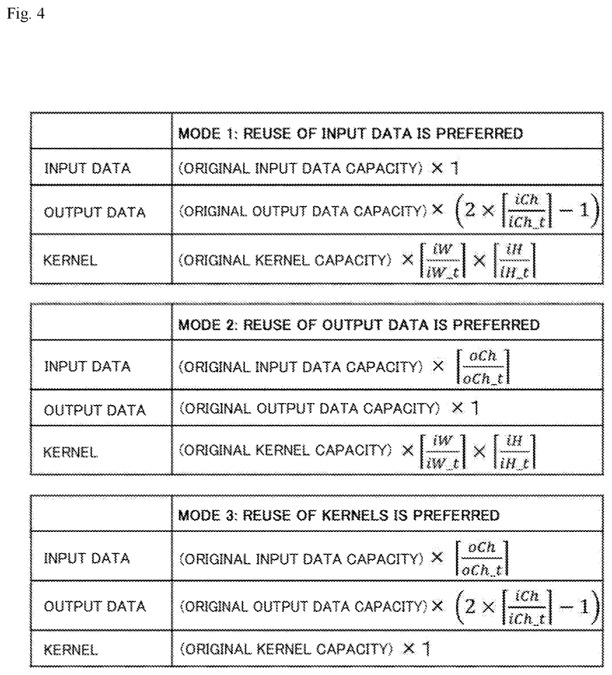

More specifically, the determination unit 33 solves a minimization problem in which a usage amount of an external memory band (input data+output data+kernel) in each mode is used as an objective function. The determination unit 33 calculates, for each mode, an objective function obtained by adding the input data, the output data, and the usage amount of the external memory band of the kernel calculated based on the calculation formula illustrated in FIG. 4. In the objective function, iW_t, iH_t, iCh_t, oW_t, oH_t and oCh_t are variables. In addition, iW, iH, iCh, oW, oH, and oCh are parameters of each layer of the CNN model. The determination unit 33 acquires CNN model information including these parameters from the outside.

The determination unit 33 also acquires the constraint condition when the objective function is minimized from the outside. A domain of each variable of the objective function is limited in accordance with the internal memory capacity for the input data, the internal memory capacity for the output data, and the internal memory capacity for the kernel by the constraint condition. The constraint condition is as follows specifically.
1. iW_t×IH_txiCh_t×number of bits per pixel≤internal memory capacity for input data
2. oW_t×oH_txoCh_t×number of bits per pixel≤internal memory capacity for output
3. k×k×iCh_t×oCh_t×number of bits per pixel≤internal memory capacity for kernel The internal memory capacity for the input data, the internal memory capacity for the output data, and the internal memory capacity for the kernel are given from the outside. In addition, k is a size of the kernel (the number of pixels in the vertical and horizontal directions).

The determination unit 33 compares minimum values of the objective functions (a sum of the usage amounts of an external memory bands) in each mode and determines a mode in which the minimum value of the objective function is the smallest as a processing mode.

For example, in Mode 1, since the input data is fixed and the output data and the kernel are slid, the input data may be read only once from the external memory, the usage amount of an external memory band is only a data capacity of original input data. On the other hand, since the output data and the kernel are read from and written to the external memory several times in accordance with the processing range, the usage amount of the external memory band becomes a constant multiple of a data capacity of the original output data and the kernel.

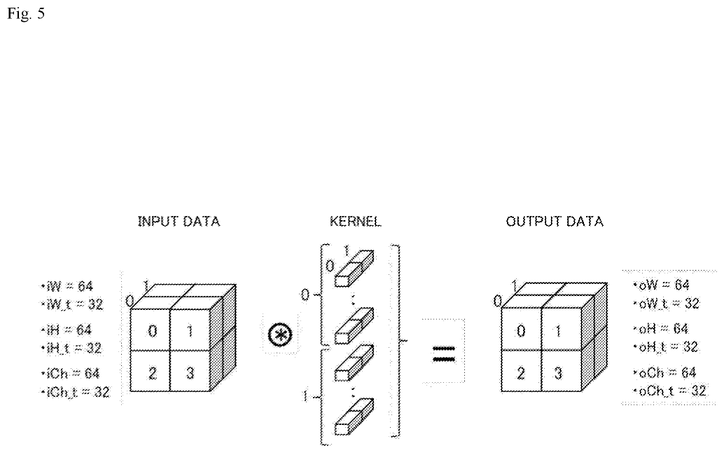

An example of processing in each mode will be described using examples of the input data, the kernel, and the output data illustrated in FIG. 5. In the example illustrated in FIG. 5, any of numbers 0) to 3 is given to each tile obtained by dividing the input data and the output data into four pieces in the vertical and horizontal directions, and each tile is divided into two pieces in the channel direction, and any of numbers 0 and 1 is given to each tile. Hereinafter, each processing range of the input data and the output data is represented by a notation in which a tile numbers and a number in the channel direction are connected by a hyphen (for example, “0-0)”). The kernel is represented by a notation in which number 0 is given to the first kernel, number 1 is given to the second kernel, and this number and a number in the channel direction are connected by a hyphen (for example, “0-0)”). In the example of FIG. 5, iW=64, iW_t=32, iH=64, iH_t=32, iCh=64, iCh_t=32, oW=64, oW_t=32, oH=64, oH_t=32, oCh=64, and oCh_t=32.

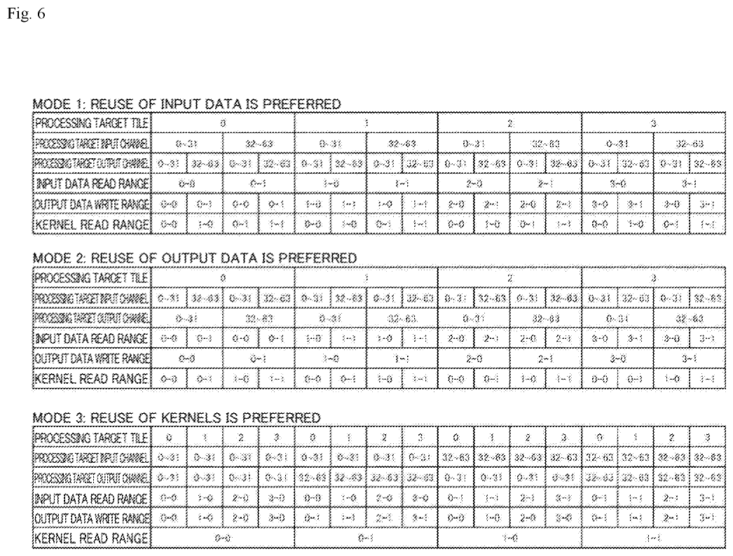

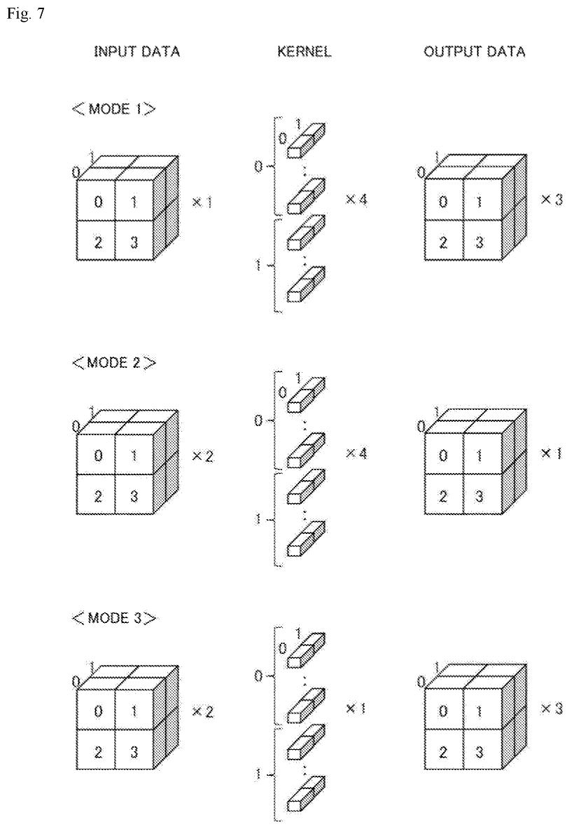

FIG. 6 illustrates an example of processing in each mode in the example of FIG. 5, FIG. 7 illustrates a calculation example of the external memory band usage of the input data, the output data, and the kernel.

In the mode 1, as illustrated in FIG. 6, for example, the processing of the data in the processing range (0-0) of the iCH=0 to 31 of tile 0 of the input data is all performed, and then the processing is shifted to the processing of the processing range (0-1) of the iCH=32 to 63 of tile 0 of the input data. Accordingly, the input data may be read from the external memory only once. That is, as illustrated in FIG. 7, in Mode 1, the usage amount of the external memory band for the input data is (original input data capacity)×1.

On the other hand, since the same kernel data (0-0) is required for processing of iCH=0 to 31 and oCH=0-31 of tile 0 and processing of iCH-0 to 31 and oCH=0 to 31 of tile 1, it is necessary to read the data from the external memory again. That is, as illustrated in FIG. 7, the usage amount of the external memory band of the kernel is (original kernel data capacity)×(number of tiles).

On the other hand, for output data, for example, in the case of processing of iCH=0 to 31 and oCH=0 to 31 of tile and the case of processing of iCH=32 to 63 and oCH=0 to 31 of tile 0, it is necessary to add each calculation result (0-0). Therefore, it is necessary to read the data from the external memory, add the data, and write the data. In this example, since OCH is processed separately in two steps, a total of three read and write operations, namely, two write operations and one read operation, are performed. That is, as illustrated in FIG. 7, the usage amount of the external memory band for the output data is (original output data capacity)×(2×number of divisions in the channel direction−1). In Modes 2 and 3, the usage amount of the external memory band is similarly calculated.

The setting unit 34 sets the processing range and the processing mode determined for each layer by the determination unit 33 in the calculation unit 35.

The calculation unit 35 reads input data and kernel data necessary for convolution calculation from each of the input image retention unit 31 and the kernel retention unit 32 to the internal memory. Then, the calculation unit 35 performs convolution calculation on the input image based on the processing range and the processing mode set for each layer by the setting unit 34, and stores the calculation result in the calculation result retention unit 36.

The calculation result retention unit 36 retains a calculation result by the calculation unit 35 and outputs the retained calculation result to the outside. The input image retention unit 31 is provided in an external memory.

### Operation of Convolutional Neural Network Inference Processing Device

Next, an operation of the convolutional neural network inference processing device 10 according to the embodiment will be described.

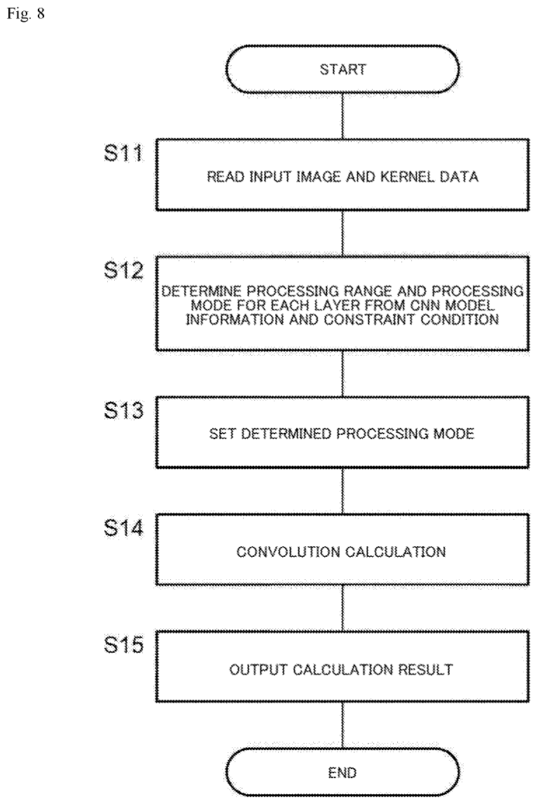

FIG. 8 is a flowchart illustrating a flow of the convolutional neural network inference processing by the convolutional neural network inference processing device 10. The CPU 11 performs convolutional neural network inference processing by reading the convolutional neural network inference processing program from the ROM 12 or the storage 14, and loading and performing the convolutional neural network inference processing in the RAM 13. The convolutional neural network inference processing illustrated in FIG. 8 is processing for one frame of an input moving image, that is, one input image. The processing on the entire input moving image is performed by repeatedly performing the convolutional neural network inference processing illustrated in FIG. 8 in units of frames.

In step S11, as the input image retention unit 31, the CPU 11 reads and retains an input image corresponding to one frame from an input moving image input to the convolutional neural network inference processing device 10. As the kernel retention unit 32, the CPU 11 reads and retains the kernel data.

Subsequently, in step S12, as the determination unit 33, the CPU 11 acquires CNN model information and a constraint condition, and determines a processing range and a processing mode for minimizing the usage amount of the external memory band for each layer of the CNN under the constraint condition corresponding to the internal memory capacity. Subsequently, in step S13, as the setting unit 34, the CPU 11 sets the processing range and the processing mode determined for each layer by the determination unit 33 in the calculation unit 35.

Subsequently, in step S14, as the calculation unit 35, the CPU 11 performs convolution calculation on the input image based on the processing range and the processing mode set for each layer by a setting unit 34, and stores the operation result in the calculation result retention unit 36. Subsequently, in step S15, as the calculation result retention unit 36. the CPU 11 outputs the calculation result to the outside and ends the convolutional neural network inference processing.

As described above, the convolutional neural network inference processing device according to the embodiment processes the entire input data by causing the plurality of convolution calculators to perform batch processing on a processing range in the input data that is input to each layer of CNN and has vertical, horizontal, and channel direction values, and sliding the processing range. The convolutional neural network inference processing device sets a processing mode for minimizing a usage amount of an external memory band in a plurality of convolution calculators for each layer of a CNN among processing modes that are based on a sliding method and include a first mode in which the input data is fixed and a kernel is slid, a second mode in which output data is fixed and the input data and the kernel are slid in a channel direction, and a third mode in which the kernel is fixed and the input data are slid in the vertical and horizontal directions. Accordingly, it is possible to reduce the usage amount of the external memory band during CNN processing.

In the above embodiment, the processing mode for minimizing the usage amount of an external memory band is determined by the determination unit included in the convolutional neural network inference processing device, but the present invention is not limited thereto. The determination unit may be included in an external device, and the setting unit may read the processing mode determined by the determination unit of the external device and set the processing mode in the calculation unit.

The convolutional neural network inference processing executed by causing the CPU to read software (program) in the above embodiment may be executed by any of various processors other than the CPU. Examples of processors used in such cases include a programmable logic device (PLD) such as a field-programmable gate array (FPGA) of which a circuit configuration can be changed after manufacturing and a dedicated electrical circuit that is a processor that has a circuit configuration such as an application specific integrated circuit (ASIC) designed to execute specific processing. The convolutional neural network inference processing may be executed by one of these various types of processors, or a combination of two or more processors of the same type or different types (for example, a combination of a plurality of FPGAs, CPUs and FPGAs, or the like). The hardware structure of these various processors is an electrical circuit in which circuit elements such as semiconductor elements are combined more specifically.

In the above embodiment, the aspect in which the convolutional neural network inference processing program is stored (installed) in advance in the ROM 12 or the storage 14 has been described, but the present disclosure is not limited thereto. The program may also be provided in a form in which the program is stored in a non-transitory storage medium such as a compact disk read only memory (CD-ROM), a digital versatile disk read only memory (DVD-ROM), or a Universal Serial Bus (USB) memory: The program may be downloaded from an external device via a network.

The following supplements are further disclosed in relation to the above embodiments.

### (Supplement 1)

A convolutional neural network inference processing device including:
a memory: and
at least one processor connected to the memory,
wherein
the processor is configured to:
   set a processing mode for minimizing a usage amount of an external memory band in a plurality of convolution calculators for each layer of a convolutional neural network among processing modes that are based on a sliding method in a case in which entire input data is processed by causing the plurality of convolution calculators to perform batch processing on a processing range in the input data that is input to each layer of the convolutional neural network and has vertical, horizontal, and channel direction values, and sliding the processing range, the processing modes including a first mode in which the input data is fixed and a kernel is slid, a second mode in which output data is fixed and the input data and the kernel are slid in a channel direction, and a third mode in which the kernel is fixed and the input data are slid in the vertical and horizontal directions: and perform convolution calculation on the input data based on the set
   processing mode.

### (Supplement 2)

A non-transitory recording medium storing a program that can be executed by a computer to execute convolutional neural network inference processing
wherein the convolutional neural network inference processing includes
   setting a processing mode for minimizing a usage amount of an external memory band in a plurality of convolution calculators for each layer of a convolutional neural network among processing modes that are based on a sliding method in a case in which entire input data is processed by causing the plurality of convolution calculators to perform batch processing on a processing range in the input data that is input to each layer of the convolutional neural network and has vertical, horizontal, and channel direction values, and sliding the processing range, the processing modes including a first mode in which the input data is fixed and a kernel is slid, a second mode in which output data is fixed and the input data and the kernel are slid in a channel direction, and a third mode in which the kernel is fixed and the input data are slid in the vertical and horizontal directions; and
   performing convolution calculation on the input data based on the set processing mode.

### REFERENCE SIGNS LIST

10 Convolutional neural network reference processing device
11 CPU
12 ROM
13 RAM
14 Storage
15 Input unit
16 Display unit
17 Communication I/F
19 Bus
31 Input image retention unit
32 Kernel retention unit
33 Determination unit
34 Setting unit
35 Calculation unit
36 Calculation result retention unit

1. A convolutional neural network inference processing device, comprising:
a memory; and
at least one processor coupled to the memory,
wherein the at least one processor is configured to:
set a processing mode for minimizing a usage amount of an external memory band in a plurality of convolution calculators for each layer of a convolutional neural network among processing modes that are based on a sliding method in a case in which entire input data is processed by causing the plurality of convolution calculators to perform batch processing on a processing range in the input data that is input to each layer of the convolutional neural network and has vertical, horizontal, and channel direction values, and sliding the processing range, the processing modes including a first mode in which the input data is fixed and a kernel is slid, a second mode in which output data is fixed and the input data and the kernel are slid in a channel direction, and a third mode in which the kernel is fixed and the input data is slid in vertical and horizontal directions; and
perform convolution calculation on the input data based on the processing mode that is set.

2. The convolutional neural network inference processing device according to claim 1, wherein the at least one processor is further configured to:
set the processing range and the processing mode for minimizing the usage amount of an external memory band under a constraint condition corresponding to an internal memory capacity.

3. The convolutional neural network inference processing device according to claim 2, wherein;
the constraint condition is that a data amount in the processing range of the input data is equal to or less than the internal memory capacity for the input data, a data amount of the kernel corresponding to the processing range is equal to or less than an internal memory capacity for the kernel, and a data amount of the output data in the processing range is equal to or less than an internal memory capacity for the output data.

4. The convolutional neural network inference processing device according to claim 1, wherein;
the usage amount of an external memory band is a value calculated by a calculation formula based on a data amount of each of the input data, the kernel, and the output data, a number of times each of the input data, the kernel, and the output data corresponding to the processing mode is read from an external memory, and a number of times each of the input data, the kernel, and the output data corresponding to the processing mode is written to the external memory.

5. The convolutional neural network inference processing device according to claim 1, further comprising wherein the at least one processor is further configured to:
determine the processing mode, and
set the processing mode that is determined.

6. The convolutional neural network inference processing device according to claim 1, wherein the at least one processor is further configured to:
receives and sets receive and set the processing mode designated from outside.

7. A convolutional neural network inference processing method, comprising, by a computer:
setting a processing mode for minimizing a usage amount of an external memory band in a plurality of convolution calculators for each layer of a convolutional neural network among processing modes that are based on a sliding method in a case in which entire input data is processed by causing the plurality of convolution calculators to perform batch processing on a processing range in the input data that is input to each layer of the convolutional neural network and has vertical, horizontal, and channel direction values, and sliding the processing range, the processing modes including a first mode in which the input data is fixed and a kernel is slid, a second mode in which output data is fixed and the input data and the kernel are slid in a channel direction, and a third mode in which the kernel is fixed and the input data is slid in vertical and horizontal directions; and
performing convolution calculation on the input data based on the processing mode that is set.

8. A non-transitory computer readable medium storing a program executable by a computer to perform a process for convolutional neural network inference processing, the process comprising:
setting a processing mode for minimizing a usage amount of an external memory band in a plurality of convolution calculators for each layer of a convolutional neural network among processing modes that are based on a sliding method in a case in which entire input data is processed by causing the plurality of convolution calculators to perform batch processing on a processing range in the input data that is input to each layer of the convolutional neural network and has vertical, horizontal, and channel direction values, and sliding the processing range, the processing modes including a first mode in which the input data is fixed and a kernel is slid, a second mode in which output data is fixed and the input data and the kernel are slid in a channel direction, and a third mode in which the kernel is fixed and the input data is slid in vertical and horizontal directions; and
performing convolution calculation on the input data based on the processing mode that is set.
